(19) United States
(12) Patent Application Publication
(10) Pub. No.: US 2011/0210290 A1
(43) Pub. Date: Sep. 1, 2011

(54) LIQUID-CRYSTALLINE POLYMER COMPOSITION AND MOLDED ARTICLE THEREOF

(75) Inventors: Hiroshi HARADA, Tsukuba-shi (JP); Hirokazu MATSUI, Tsukuba-shi (JP)

(73) Assignee: SUMITOMO CHEMICAL COMPANY, LIMITED, Tokyo (JP)

(21) Appl. No.: 13/034,049

(22) Filed: Feb. 24, 2011

(30) Foreign Application Priority Data
Feb. 26, 2010 (JP) 2010-041899

(51) Int. Cl. C09K 19/06; C09K 19/00

(52) U.S. Cl. 252/299.6; 252/299.01

(57) ABSTRACT

The present invention provides a liquid-crystalline polymer composition comprising:

a liquid-crystalline polymer and an aromatic polysulfone resin having oxygen-containing groups selected from among hydroxyl groups and oxyanion groups in an amount of 6×10⁻⁵ or more in number per 1 g of the polysulfone resin. The composition can suppress rise of specific gravity and reduction of heat resistance and can stably provide a molded article having excellent mechanical characteristics.

### BACKGROUND OF THE INVENTION

(1) Field of the Invention

The present invention relates to a liquid-crystalline polymer composition and its molded article.

(2) Description of Related Art

A liquid-crystalline polymer and particularly, a liquid-crystalline polymer having melt liquid-crystallinelinity has the characteristics that it has a rigid molecular skeleton and develops liquid-crystallinelinity when melted and its molecular chain is oriented when it is fluidized by shearing or by extension. Such characteristics allow the polymer to exhibit excellent fluidity when it is melt-processed by, for example, injection molding, extrusion molding, inflation molding and blow molding and also, to provide a molded article having excellent mechanical properties. Particularly, an aromatic liquid-crystalline polymer provides molded articles having high chemical stability, heat resistance, high strength and high rigidity derived from its rigid molecular skeleton besides excellent fluidity when it is molded, and is therefore useful as engineering plastics including electric/electronic appliances for which light-weighting, thinning and miniaturization are demanded.

However, though the liquid-crystalline polymer has excellent characteristics, molding conditions, particularly, the mold temperature, strongly affect the variation in properties, giving rise to a problem that a molded article having stable properties is not obtained. This reason is that because the liquid-crystalline polymer is provided with molecular chain orientation due to its liquid-crystallinelinity in shear flow and extension flow when it is molded and the molecular chain orientation contributes to the development of mechanical properties, the mechanical properties vary depending on the condition of the formation of the molecular chain orientation in a molded article, that is, the condition of the molecular chain orientation due to the flow upon molding and the condition of orientation maintained during the course of cooling to solidify. That is, the molding condition having an influence on the generation of molecular chain orientation and on the fixation of the orientation strongly affects the mechanical properties of the molded article. The molecular chain orientation is caused by shear flow and extension flow and relaxed when the molecule is released from shear flow or extension flow. Therefore, a cooling process in which shaping (shearing and extension are applied) and solidification (competition with relaxation) progress simultaneously largely affects the properties of the molded article. In the case of injection molding or extrusion molding, a process of filling the polymer in a mold is a process in which the fluidization/shaping and cooling-solidification of a plasticized resin progress simultaneously and which progress in an extremely dynamic circumstance. Therefore, conditions of the process, particularly, the mold temperature, have a large influence, giving rise to a problem that the properties of the obtained molded article are unstable. Also, though the molding conditions largely affect on the properties of the molded article, the range of proper molding conditions for obtaining a required shape and properties is limited, thereby giving rise to problems concerning difficult molding in obtaining a molded article having a complicated shape and a fine shape and increase in molding cycle time, and leading to deteriorated productivity.

Therefore, the addition of glass fibers and inorganic fillers which may be used as a reinforcing filler with the intention of improving strength and heat resistance not only has one side as a reinforcing filler but also is important as a method in which molecular chain orientation in flowing is disordered to thereby weaken the influence of molding conditions on the mechanical properties of a molded article, thereby stabilizing the properties of the molded article.

On the other hand, studies are being made so as to compound other polymers in a liquid-crystalline polymer and, for example, Japanese Unexamined Patent Publication No. (JP-A-) 2000-53849 discloses that a molded article is obtained which is reduced in anisotropy and improved in warpage and weld strength by compounding a polyester type thermoplastic elastomer in a thermotropic liquid-crystalline polymer.

### SUMMARY OF THE INVENTION

However, the compounding of glass fibers and inorganic fillers is contrary to light-weighting which is a part of the light-weighting, thining and miniaturization because the specific gravity is increased if these fibers or fillers are added in an amount enough to weaken the influence of the molding conditions on the mechanical properties of a molded article. Furthermore, the compounding of glass fibers and inorganic fillers also has such a demerit that it deteriorates a part (tensile strength and impact strength) of the excellent characteristics developed by the orientation of the liquid-crystalline polymer.

On the other hand, the technique disclosed in the publication JP-A-2000-53849 poses a problem that the compounding of a polyester type thermoplastic elastomer brings about easy deterioration in characteristics such as heat resistance, which the liquid-crystalline polymer has. Also, even if the effect of reduction in anisotropy is observed, the influence of molding conditions on the properties of the molded article is not eliminated.

In view of this situation, it is an object of the present invention to provide a liquid-crystalline polymer composition which can suppress rise of specific gravity and reduction of heat resistance and can stably provide a molded article having excellent mechanical characteristics by reducing the influence of the molding conditions, particularly, the mold temperature.

In order to achieve the above object, the present invention provides a liquid-crystalline polymer composition comprising:

a liquid-crystalline polymer and

an aromatic polysulfone resin having oxygen-containing groups selected from among hydroxyl groups and oxyanion groups in an amount of 6×10⁻⁵ or more in number per 1 g of the polysulfone resin. The present invention also provides a molded article obtained by molding the liquid-crystalline polymer composition.

According to the liquid-crystalline polymer composition of the present invention, a molded article which is suppressed in the rise of specific gravity and reduction in heat resistance and has excellent mechanical characteristics can be stably provided.

### PREFERRED EMBODIMENTS OF THE INVENTION

### <Liquid-Crystalline Polymer>

A liquid-crystalline polymer is a polymer which exhibits optical anisotropy when it is melted and forms an anisotropic melt body at a temperature of 500° C. or less. This optical anisotropy can be confirmed by a usual polarization detection method utilizing a cross polarizer. A liquid-crystalline polymer has a molecular chain which has an elongated flat molecular shape and also has a high rigidity along the long chain of the molecule (hereinafter, the molecular chain having high rigidity is sometimes called “mesogenic group”), wherein the mesogenic group is present on one or both of a main chain and a side chain of the polymer. When higher heat resistance is required, a liquid-crystalline polymer having a mesogenic group at its main chain is preferable.

Examples of the liquid-crystalline polymer include liquid-crystalline polyester, liquid-crystalline polyester amide, liquid-crystalline polyester ether, liquid-crystalline polyester carbonate, liquid-crystalline polyester imide and liquid-crystalline polyamide. Among them, liquid-crystalline polyester, liquid-crystalline polyester amide and liquid-crystalline polyamide are preferable from the viewpoint of obtaining a high-strength molded article.

Preferable examples of the liquid-crystalline polymer include the following (a) to (c) and two or more thereof may be used.

(a): Liquid-crystalline polyester, liquid-crystalline polyester amide or liquid-crystalline polyamide having the following structural unit (I) and/or structural unit (II).

(b): Liquid-crystalline polyester or liquid-crystalline polyester amide having a structural unit selected from the following structural units (I) and (II), and the following structural units (III) and (IV).

(c): Liquid-crystalline polyester or liquid-crystalline polyester amide having a structural unit selected from the following structural units (I) and (II), the following structural unit (III) and a structural unit selected from the following structural units (IV), (V) and (VI).

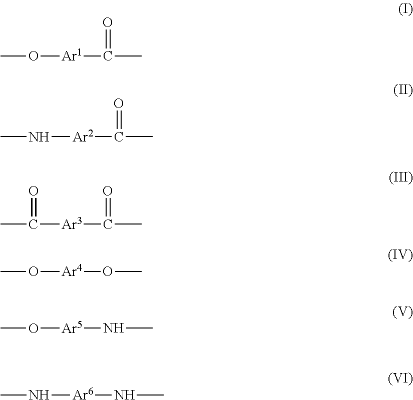

In the formula, each of Ar¹, Ar², Ar⁵ and Ar⁶ independently represents a divalent aromatic group, each of Ar³ and Ar⁴ independently represents a divalent group selected from an aromatic group, an alicyclic group and an aliphatic group. In this case, a part or all of hydrogen atoms on the aromatic ring of the above aromatid group may be substituted with a halogen atom, an alkyl group or alkoxy group having 1 to 10 carbon atoms or an aryl group having 6 to 10 carbon atoms. Here, the alicyclic group means a group obtained by eliminating two hydrogen atoms from an alicyclic compound and the aliphatic group means a group obtained by eliminating two hydrogen atoms from an aliphatic compound.

The aromatic group represented by Ar¹, Ar², Ar⁵ or Ar⁶ in the above structural unit is a group obtained by eliminating two hydrogen atoms bonded to the aromatic ring of an aromatic compound selected from the group consisting of monocyclic aromatic compounds, condensed aromatic compounds and aromatic compounds in which a plurality of aromatic rings are linked by a divalent linking group (including a single bond) and is preferably a divalent aromatic group selected from 2,2-diphenylpropane, a 1,4-phenylene group, a 1,3-phenylene group, a 2,6-naphthalenediyl group and a 4,4′biphenylene group. A liquid-crystalline polymer provided with such a group as the aromatic group is preferable because it tends to have excellent mechanical strength.

The structural unit (I) is a structural unit derived from an aromatic hydroxycarboxylic acid. Examples of the aromatic hydroxycarboxylic acid include 4-hydroxybenzoic acid, 3-hydroxybenzoic acid, 6-hydroxy-2-naphthoic acid, 7-hydroxy-2-naphthoic acid, 6-hydroxy-1-naphthoic acid, 4′-hydroxybiphenyl-4-carboxylic acid or aromatic hydroxycarboxylic acids in which a part or all of hydrogen atoms on the aromatic ring of these aromatic hydroxycarboxylic acids are substituted with an alkyl group, an alkoxy group, or a halogen atom. In this case, examples of the alkyl group include a straight chain, branched chain or alicyclic alkyl group having 1 to 6 carbon atoms, such as a methyl group, an ethyl group, a propyl group, an isopropyl group, a butyl group, a tert-butyl group, a hexyl group, and a cyclohexyl group. Examples of the alkoxy group include a straight chain, branched or alicyclic alkoxy group such as a methoxy group, an ethoxy group, a propoxy group, an isopropoxy group, a butoxy group, a tert-butoxy group, a hexyloxy group, and a cyclohexyloxy group. Examples of the aryl group include a phenyl group and a naphthyl group. The halogen atom is selected from a fluorine atom, a chlorine atom, a bromine atom and an iodine atom.

The structural unit (II) is a structural unit derived from an aromatic aminocarboxylic acid and examples of the aromatic aminocarboxylic acid include 4-aminobenzoic acid, 3-aminobenzoic acid, and 6-amino-2-naphthoic acid or aromatic aminocarboxylic acids in which a part or all of hydrogen atoms on the aromatic ring of these aromatic aminocarboxylic acids are substituted with an alkyl group, an alkoxy group, an aryl group or a halogen atom. Here, examples of each of the alkyl group, alkoxy group, aryl group and halogen atom are the same as those given as the examples in the case of the above aromatic hydroxycarboxylic acid.

The structural unit (V) is a structural unit derived from an aromatic hydroxyamine and examples of the aromatic hydroxyamine include 4-aminophenol, 3-aminophenol, 4-amino-1-naphthol, and 4-amino-4′-hydroxydiphenyl or aromatic hydroxyamines in which a part or all of hydrogen atoms on the aromatic ring of these aromatic hydroxyamines are substituted with an alkyl group, an alkoxy group, an aryl group or a halogen atom. Here, examples of each of the alkyl group, alkoxy group, aryl group and halogen atom are the same as those given as the examples in the case of the above aromatic hydroxycarboxylic acid.

The structural unit (VI) is a structural unit derived from an aromatic diamine and examples of the aromatic diamine include 1,4-phenylenediamine, 1,3-phenylenediamine, 4,4′-diaminophenyl sulfide (thiodianiline), 4,4′-diaminodiphenylsulfone, and 4,4′-diaminodiphenyl ether (oxydianiline) or aromatic diamines in which a part or all of hydrogen atoms on the aromatic ring of these aromatic diamines are substituted with an alkyl group, an alkoxy group, an aryl group or a halogen atom, and aromatic diamines in which hydrogen atoms bonded to the primary amino group of the aromatic diamines exemplified above are substituted with an alkyl group. Here, examples of each of the alkyl group, alkoxy group, aryl group and halogen atom are the same as those given as the examples in the case of the above aromatic hydroxycarboxylic acid.

Ar³ in the above structural unit (III) and Ar⁴ in the structural unit (IV) respectively represent, besides the aromatic groups described for Ar¹, Ar², Ar⁵ and Ar⁶, a group selected from a divalent aliphatic group and a divalent alicyclic group obtained by eliminating two hydrogen atoms from a saturated aliphatic compound having 1 to 9 carbon atoms.

The structural unit (III) is a group derived from an aromatic dicarboxylic acid or an aliphatic dicarboxylic acid. Examples of the aromatic dicarboxylic acid include terephthalic acid, 4,4′-diphenyldicarboxylic acid, 4,4″-triphenyldicarboxylic acid, 2,6-naphthalenedicarboxylic acid, diphenyl ether-4,4′-dicarboxylic acid, isophthalic acid, and diphenyl ether-3,3′-dicarboxylic acid or aromatic dicarboxylic acids in which a part or all of hydrogen atoms on the aromatic ring of these aromatic dicarboxylic acids are substituted with an alkyl group, an alkoxy group, an aryl group or a halogen atom.

Examples of the aliphatic dicarboxylic acid include alicyclic dicarboxylic acids such as malonic acid, succinic acid, adipic acid, trans-1,4-cyclohexanedicarboxylic acid, cis-1,4-cyclohexanedicarboxylic acid, 1,3-cyclohexanedicarboxylic acid; trans-1,4-(1-methyl)cyclohexane dicarboxylic acid and trans-1,4-cyclohexanedicarboxylic acid or aliphatic dicarboxylic acids in which a part or all of hydrogen atoms on the aliphatic group or alicyclic group of these aliphatic dicarboxylic acids are substituted with an alkyl group, an alkoxy group, an aryl group or a halogen atom. In this case, examples of each of the alkyl group, alkoxy group, aryl group, and halogen atom are the same as those given as the examples in the case of the above aromatic hydroxycarboxylic acid.

The structural unit (IV) is a group derived from an aromatic diol and an aliphatic diol. Examples of the aromatic diol include hydroquinone, resorcin, naphthalene-2,6-diol, 4,4′-biphenylenediol, 3,3′-biphenylenediol, 4,4′-dihydroxydiphenyl ether, and 4,4′-dihydroxydiphenylsulfone or aromatic diols in which a part or all of hydrogen atoms on the aromatic ring of these aromatic diols are substituted with an alkyl group, an alkoxy group, an aryl group or a halogen atom.

Examples of the aliphatic diol include ethylene glycol, propylene glycol, butylenediol, neopentyl glycol, 1,6-hexanediol, trans-1,4-cyclohexanediol, cis-1,4-cyclohexanediol, trans-1,4-cyclohexanedimethanol, cis-1,4-cyclohexanedimethanol, trans-1,3-cyclohexanediol, cis-1,2-cyclohexanediol and trans-1,3-cyclohexanedimethanol or aliphatic diols in which a part or all of hydrogen atoms on the aliphatic group or alicyclic group of these aliphatic diols are substituted with an alkyl group, an alkoxy group, an aryl group or a halogen atom.

In this case, examples of each of the alkyl group, alkoxy group, aryl group and halogen atom are the same as those given as the examples in the case of the above aromatic hydroxycarboxylic acid.

In the above preferable liquid-crystalline polymer, (b) or (c) may contain an aliphatic group in the structural units (III) and (IV). In this case, the amount of the aliphatic group to be introduced into the liquid-crystalline polymer is selected from the range where the liquid-crystalline polymer is allowed to develop liquid-crystallinelinity and from the range where the heat resistance of the liquid-crystalline polymer is not significantly impaired. When the sum of Ar¹ to Ar⁶ in the liquid-crystalline polymer applied to the present invention is set to 100 mol %, the sum of divalent aromatic groups is preferably 60 mol % or more, more preferably 75 mol % or more and even more preferably 90 mol % or more. A full aromatic liquid-crystalline polymer in which the sum of divalent aromatic groups is 100 mol % is even more preferable.

Among preferable full aromatic liquid-crystalline polymers, the liquid-crystalline polyester (a) or (b) is preferable and the liquid-crystalline polyester (b) is particularly preferable. Among the liquid-crystalline polyesters (b), liquid-crystalline polyesters including a structural unit derived from an aromatic hydroxycarboxylic acid represented by the following formula (I-1) and/or (I-2), a structural unit derived from at least one aromatic dicarboxylic acid selected from the group consisting of compounds represented by the following formulae (III-1), (III-2) and (III-3) and a structural unit derived from at least one aromatic diol selected from the group consisting of compounds represented by the following formulae (IV-1), (IV-2), (IV-3) and (IV-4) have an advantage that a molded article is easily obtained which is improved to a high level in all the characteristics including moldability, heat resistance, high mechanical strength and flame retardance.

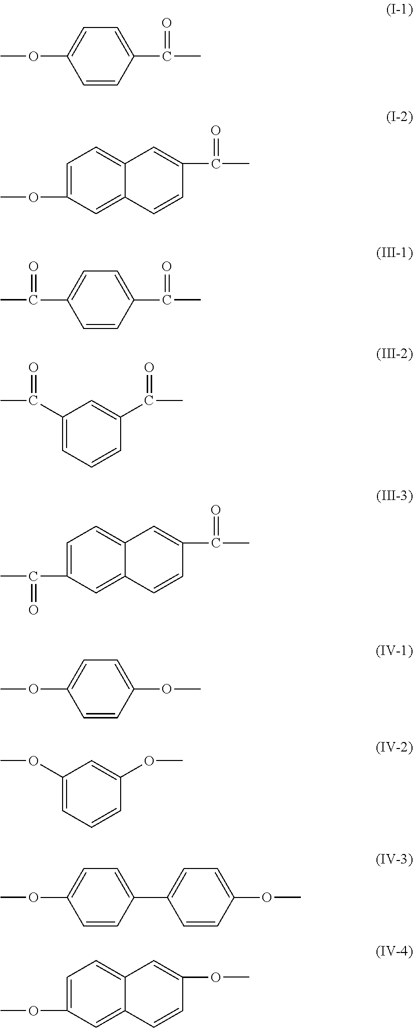

The liquid-crystalline polymer can be produced by using, as raw material monomers, an aromatic hydroxycarboxylic acid and/or an aromatic aminocarboxylic acid in the case of the above (a), an aromatic hydroxycarboxylic acid and/or an aromatic aminocarboxylic acid, an aromatic dicarboxylic acid and/or an aliphatic dicarboxylic acid, and an aromatic diol and/or an aliphatic diol in the case of the above (b), and an aromatic hydroxyl carboxylic acid and/or an aromatic aminocarboxylic acid, an aromatic dicarboxylic acid and/or an aliphatic dicarboxylic acid, and at least one compound selected from an aromatic diol, an aliphatic diol, an aromatic hydroxylamine and an aromatic diamine in the case of the above (c), and by polymerizing these raw material monomers by a known polymerization method.

The liquid-crystalline polyester (b) which is a more preferable liquid-crystalline polymer can be obtained by using an aromatic hydroxycarboxylic acid, an aromatic dicarboxylic acid and an aromatic diol as raw material monomers and by polymerizing these monomers.

Though the aforementioned raw material monomers may be directly polymerized to produce the liquid-crystalline polymer as mentioned above, it is preferable to undergo polymerization after a part of the raw material monomers are converted into an ester forming derivative/amide forming derivative (hereinafter collectively sometimes referred to as an ester/amide forming derivative) in order to carry out the polymerization easily. The ester/amide forming derivative means a compound having a group which promotes an ester formation reaction or an amide formation reaction. Specific examples thereof include ester/amide forming derivatives obtained by converting a carboxyl group in a monomer molecule into a haloformyl group, acid anhydride, or ester and ester/amide forming derivatives obtained by converting a phenolic hydroxyl group and a phenolic amino group in a monomer molecule into an ester group and an amide group respectively.

A method of producing the liquid-crystalline polyester (b) by converting a part of raw materials into an ester/amide forming derivative to polymerize will be briefly described. The liquid-crystalline polyester can be produced, for example, by the method described in Japanese Unexamined Patent Publication No. 2002-146003. First, an acylated compound obtained by using acid anhydride, preferably acetic acid anhydride, to convert a phenolic hydroxyl group of an aromatic hydroxycarboxylic acid and an aromatic diol is produced. Then, de-acetic acid polymerization condensation is carried out in such a manner as to undergo ester-exchange between an acyl group of the acylated compound thus obtained and carboxyl groups of the acylated aromatic hydroxycarboxylic acid and aromatic dicarboxylic acid, to thereby produce a liquid-crystalline polyester. This de-acetic acid polymerization condensation can be attained by melt polymerization carried out in the conditions of a reaction temperature of 150 to 400° C. and a reaction time of 0.5 to 8 hours. In the melt polymerization, a liquid-crystalline polyester having a relatively lower molecular weight (hereinafter, referred to as “prepolymer”) is obtained. The prepolymer is preferably made to have a higher molecular weight to further improve the characteristics of the liquid-crystalline polyester itself, and solid-phase polymerization is preferably carried out to obtain a higher molecular weight. The solid-phase polymerization is a polymerization method in which the prepolymer is milled into a powder, which is then heated in the solid-phase state remaining unchanged. The use of the solid-phase polymerization more progresses polymerization, enabling the production of a liquid-crystalline polyester having a higher molecular weight.

### <Aromatic Polysulfone Resin>

The aromatic polysulfone resin is one having an aromatic group and a sulfonyl group in the main chain skeleton. The aromatic polysulfone resin to be used in the present invention has oxygen-containing groups selected from among hydroxyl groups and oxyanion groups in an amount of 6×10⁻⁵ or more in number per 1 g of the polysulfone resin. If such a specified aromatic polysulfone resin is compounded in the liquid-crystalline polymer, a liquid-crystalline polymer composition which can stably provide a molded article, can suppress rise of specific gravity and reduction of heat resistance and has excellent mechanical characteristics can be obtained. The content of the above hydroxyl groups is preferably 8×10⁻⁵ or more in number per 1 g of the aromatic polysulfone resin. Also, the content of the oxygen-containing groups described above (such as hydroxyl groups and oxyanion groups) may be 20×10⁻⁵ or less and preferably 17×10⁻⁵ or less in number per 1 g of the aromatic polysulfone resin from the viewpoint of suppressing a reduction in strength.

All of the oxygen-containing groups are preferably a hydroxyl group from the viewpoint of improving the stability of the liquid-crystalline polymer composition in melt processing. The oxygen-containing groups are preferably bonded to aromatic ring(s) of the aromatic polysulfone resin so as to serve as phenolic hydroxyl or oxyanion groups thereof. Also, the oxygen-containing group(s) are preferably placed at terminal(s) of amain chain of the aromatic polysulfone resin.

The oxyanion group typically exists with a counter-cation attached thereto. Examples of the counter-cation include alkali metal ions such as a lithium.ion, a sodium ion and a potassium ion, alkaline earth metal ions such as a magnesium ion and a calcium ion, ammonium ions obtained by protonating ammonia or primary to tertiary amine, and quaternary ammonium ions. When the counter-cation is a polyvalent cation such as an alkaline earth metal ion, the counter-anion may be comprised of a plurality of oxyanion groups, or may be comprised of an oxyanion group, and other anions such as a chloride ion and a hydroxide ion.

The aromatic polysulfone resin preferably has a repeat unit represented by the following formula (1) (hereinafter sometimes referred to as a “repeat unit (1)”) since a molded article obtained from the resulting composition tends to be excellent in heat resistance, mechanical strength, flame retardance and chemical resistance and tends to reduce the generation of gas in molding step. The aromatic polysulfone resin may have a repeat unit represented by the following formula (2) (hereinafter sometimes referred to as a “repeat unit (2)”) and/or a repeat unit represented by the following formula (3) (hereinafter sometimes referred to as a “repeat unit (3)”). When the aromatic polysulfone resin having the a repeat unit represented by the formula (1) is used, the content of the repeat unit (1) in the aromatic polysulfone resin is preferably 50 mol % or more and more preferably 80 mol % or more based on the total amount of all the repeat units.

-Ph¹-SO₂-Ph²-O— (1)

Ph¹ and Ph² each independently represent a group represented by the following formula (4).

-Ph³-R-Ph⁴-O— (2)

Ph¹ and Ph⁴ each independently represent a group represented by the following formula (4) and R represents an alkylidene group or an alkylene group having 1 to 3 carbon atoms, an oxygen atom or a sulfur atom.

-(Ph⁵)ₙ-O— (3)

Ph⁵ represents a group represented by the following formula (4), and n represents an integer from 1 to 5. When n is 2 or more, plural Ph⁵s may be the same or different.

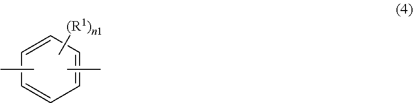

R¹ represents an alkyl group having 1 to 3 carbon atoms, a halogeno group, a sulfo group, a nitro group, an amino group, a carboxyl group, a phenyl group, or an oxygen-containing group selected from among hydroxyl group and oxyanion group. n1 represents an integer from 0 to 2, wherein two R¹s may be the same or different when n1 is 2.

The reduced viscosity of the aromatic polysulfone resin is preferably 0.25 to 0.60 dl/g. When the aromatic polysulfone resin with too small reduced viscosity is used, then the mechanical strength or chemical resistance of a molded article obtained from the resulting liquid-crystalline polymer composition of the present invention tends to become low, and also a gas generated in molding the composition may be increased, undesirably. When the aromatic polysulfone resin with too large reduced viscosity (which may corresponding to the difficulty of the polysulfone resin to have the amount of the oxygen-containing group as described above) is used, then the resulting molded article may be unstable in physical properties depending on the molding conditions, or the flowability of the resulting liquid-crystalline polymer composition may be deteriorated due to the increase in melting viscosity of the aromatic polysulfone resin. Considering the balance in stability, processability and physical properties (such as mechanical strength, chemical resistance and gas-generating property) of the resulting molded article, the reduced viscosity is more preferably 0.30 to 0.55 dl/g and even more preferably 0.36 to 0.55 dl/g.

Examples of a method of producing the aromatic polysulfone resin include a method in which a corresponding dihydric phenol and a dihalogenobenzenoid compound are polycondensed in an organic high-polar solvent by using an alkali metal salt of carbonic acid. At this time, the molar ratio of the raw materials and reaction temperature are adjusted in consideration of side reactions such as a depolymerization reaction of the aromatic polysulfone resin by the by-produced alkali hydroxide and a substitution reaction of the halogeno group to be the Oxygen-containing group such as a hydroxyl group and an oxyanion grouphydroxyl group, thereby enabling the oxygen-containing groups to be introduced into the resulting aromatic polysulfone resin in the amount described above.

Examples of the dihydric phenol include 4,4′-dihydroxydiphenylsulfone, bis(4-hydroxy-3,5-dimethylphenyl)sulfone, 4,4′-sulfonyl-2,2′-diphenylbisphenol, hydroquinone, resorcin, catechol, phenylhydroquinone, 2,2-bis(4-hydroxyphenyl)propane, 2,2-bis(4-hydroxyphenyl)hexafluoropropane, 4,4′-dihydroxydiphenyl, 2,2′-dihydroxydiphenyl, 3,5,3′,5′-tetramethyl-4,4′-dihydroxydiphenyl, 2,2′-diphenyl-4,4′-bisphenol, 4,4′″-dihydroxy-p-quarter-phenyl, 4,4′-dihydroxydiphenyl sulfide, bis(4-hydroxy-3-methylphenyl)sulfide, and 4,4′-oxydiphenol.

Examples of the dihalogenobenzenoid compound include 4,4′-dichlorodiphenylsulfone, 4-chlorophenyl-3′,4′-dichlorophenylsulfone, and 4,4′-bis(4-chlorophenylsulfonyl)diphenyl. As the dihalogenobenzenoid compound, those in which the halogen atom is activated by the sulfonyl group bonded at the para-position with respect to the halogen atom are preferable.

A compound having a phenolic hydroxyl group and a halogen atom, for example, 4-hydroxy-4′-(4-chlorophenylsulfonyl)biphenyl may also be used in place of all or part of the dihydric phenol and dihalogenobenzenoid compound.

The amount of the dihalogenobenzenoid compound to be used is preferably 80 to 105 mol % based on the dihydric phenol in order to introduce the oxygen-containing group such as a hydroxyl group and an oxyanion group into the main chain of the aromatic polysulfone resin. In order to obtain a higher molecular weight of the aromatic polysulfone resin, the amount of the dihalogenobenzenoid compound to be used is preferably 98 to 105 mol %.

Examples of the organic high-polar solvent include dimethylsulfoxide, 1-methyl-2-pyrrolidone, sulfolane, 1,3-dimethyl-2-imidazolidinone, 1,3-diethyl-2-imidazolidinone, dimethylsulfone, diethylsulfone, diisopropylsulfone and diphenylsulfone.

The alkali metal salt of carbonic acid may be commonly-used salts such as sodium carbonate and potassium carbonate or acid salts such as sodium bicarbonate and potassium bicarbonate or a combination of the both. In order to have the molecular weight of the aromatic polysulfone resin increased and to introduce the oxygen-containing group into the main chain of the aromatic polysulfone resin, the amount of the alkali metal salt of carbonic acid is preferably 0.95 mol equivalent or more based on the phenolic hydroxyl group of the dihydric phenol. When the amount of the dihalogenobenzenoid compound is in a range of from 80 to 98 mol % based on the dihydric phenol, the amount of the alkali metal salt of carbonic acid is preferably used in an amount of from 0.95 to 1.005 equivalent in terms of alkali metal based on the phenolic hydroxyl group of the dihydric phenol. When the amount of the dihalogenobenzenoid compound is in a range of from 98 to 105 mol % based on the dihydric phenol, the amount of the alkali metal salt of carbonic acid is preferably used in an amount of from 1.005 to 1.40 equivalent in terms of alkali metal based on the phenolic hydroxyl group of the dihydric phenol. When the amount of the alkali metal salt of carbonic acid to be used is too large, it causes easy cleavage and decomposition of the aromatic polysulfone resin to be produced, which result in reducing the molecular weight of the polysulfone resin. On the other hand, when the amount of the alkali metal salt of carbonic acid to be used is too small, the polymerization tends to insufficiently proceed, which may result in difficulty of obtaining the high-molecular polysulfone resin, or in decrease in the oxygen-containing group of the polysulfone resin, undesirably.

In a typical production method, the dihydric phenol and the dihalogenobenzenoid compound are dissolved in an organic polar solvent in a first stage, the alkali metal salt of carbonic acid is added to the obtained solution to undergo polycondensation of the dihydric phenol and the dihalogenobenzenoid compound in a second stage, and an unreacted alkali metal salt of carbonic acid, alkali metal salts such as by-produced alkali metal halides and the organic polar solvent are removed from the obtained reaction mixture to obtain a polysulfone (A) in a third stage.

Here, the dissolution temperature in the first stage may be in the range of from 40 to 180° C., while the polycondensation temperature in the second stage may be in the range of from 180 to 400° C. A higher polycondensation temperature brings about a tendency to give a polysulfone (A) having a higher molecular weight and is therefore desirable. However, an excessively high temperature easily gives rise to side reactions such as decomposition and is therefore undesirable. An excessively low temperature, on the other hand, causes retardation of the reaction and is therefore undesirable. It is preferable that the temperature of the reaction system is gradually raised with removing by-produced water and the mixture is further stirred for 1 to 50 hours and preferably 10 to 30 hours after the temperature reaches the reflux temperature of the organic polar solvent.

When the dihalogenobenzenoid compound is used in the amount of from 80 to 98 mol % based on the dihydric phenol, the following process is preferably adopted in place of the above first and second stages: first, the alkali metal salt of carbonic acid, dihydric phenols and the organic polar solvent may be mixed and reacted to remove by-produced water in advance. When the dihalogenobenzenoid compound is used in the amount of from 98 to 105 mol % based on the dihydric phenol, this process may not be preferred since the amount of the oxygen-containing group of the polysulfone resin becomes smaller. In conduction the process, azeotropic dehydration may be performed in order to remove water from the reaction solution, by mixing the resulting reaction solution with an organic solvent which forms an azeotrope with water. Examples of the organic solvent which forms an azeotrope with water include benzene, chlorobenzene, toluene, methyl isobutyl ketone, hexane and cyclohexane. The azeotropic dehydration temperature may be in the range of from 70 to 200° C. although it depends on the temperature at which the azeotropic solvent forms an azeotrope with water.

Then, the reaction is continued until the solvent and water form no azeotrope and then, the dihalogenobenzenoid compound is mixed to undergo polycondensation at typically 180 to 400° C. in the same manner as above. In this case, as the polycondensation temperature is higher, an aromatic polysulfone resin having a higher molecular weight tends to be obtained and is therefore preferable. If the temperature is too high, it is undesirable because side reactions such as decomposition tend to occur. If the temperature is too low on the other hand, it causes retardation of the reaction and is therefore undesirable.

In the third stage, an alkali metal salt of carbonic acid and alkali metal salts such as by-produced alkali metal halides can be removed from the reaction mixture by a filter or a centrifugal separator to obtain a solution in which the aromatic polysulfone resin is dissolved in an organic polar solvent. The organic polar solvent can be removed from the solution to thereby obtain an aromatic polysulfone resin. For the removal of the organic polar solvent, there can be adopted a method in which the organic polar solvent is directly distilled off from the aromatic polysulfone resin solution or a method in which the aromatic polysulfone resin solution is added once in a poor solvent for the aromatic polysulfone resin to precipitate the polysulfone resin, which is then separated by, for example, filtration or centrifugal separation.

Alternatively, in the case where an organic polar solvent having a relatively high melting point is used as the polymerization solvent, the following method may be adopted. Specifically, after the second stage, the reaction mixture is cooled to solidify, the solid solution is milled and then, water, and a solvent which cannot dissolve the aromatic polysulfone resin but can dissolve the organic polar solvent are used to extract and remove unreacted alkali metal salts of carbonic acid, alkali metal salts such as by-produced alkali metal halides and the organic polar solvent.

The particle diameter of the milled particles is preferably 50 to 2000 μm as the center particle diameter in view of extraction efficiency and workability in the extraction operation. If the particle diameter of the milled particles is too large, the extraction efficiency is deteriorated whereas if the milled particle diameter is too small, particles are consolidated in the extraction of the solution and clogging is caused when filtration or drying is carried out after the extraction process, and therefore, both cases are undesirable. The milled particle diameter is preferably 100 to 1500 μm and more preferably 200 to 1000 μm.

As the extraction solvent, a mixed solvent of acetone and methanol may be used when, for example, diphenylsulfone is used as the polymerization solvent. Here, the mixing ratio of acetone and methanol is preferably determined based on the extraction efficiency and fixation of the aromatic polysulfone resin.

Examples of commercially available products of the aromatic polysulfone resin include “Sumikaexcel 5003P” manufactured by Sumitomo Chemical Co., Ltd.

### <Liquid-Crystalline Polymer Composition>

The liquid-crystalline polymer composition of the present invention comprises the polysulfone resin and the liquid-crystalline polymer, each example of them being described above. In the composition, the content of the aromatic polysulfone resin is preferably in a range of from 0.5 to 100 parts by weight based on 100 parts by weight of the liquid-crystalline polymer. When the content of the aromatic polysulfone resin is too small, the resulting molded article may be unstable in physical properties depending on the molding conditions. When the content of the aromatic polysulfone resin is too large, on the other hand, the molding processability of the resulting composition tends to be lowered. For example, when the content of the aromatic polysulfone resin is too large, high flowability (that is one of characteristics of the liquid-crystalline polymer) in molding and high heat resistance and mechanical strength of the resulting molded article tend to be deteriorated. Considering the balance in physical properties (such as stability and heat resistance) of the resulting molded article and flowability and process stability of the composition in molding, the content of the aromatic polysulfone resin in the composition is more preferably in a range of from 2 to 50 parts by weight, and most preferably in a range of from 5.25 to 12 parts by weight, based on 100 parts by weight of the liquid-crystalline polymer.

The liquid-crystalline polymer composition of the present invention may further contain a component other than the liquid-crystalline polymer and the aromatic polysulfone, as necessary to improve, for example, mechanical strength and heat resistance. Examples of the other component include fillers such as a fibrous filler, a plate filler, a spherical filler, a powder filler, a hetero filler, and a whisker and, besides, colorants, lubricants, various surfactants, antioxidants, heat stabilizers, ultraviolet absorbers and antistatic agents.

Examples of the fibrous filler include glass fibers, PAN type carbon fibers, pitch type carbon fibers, silica-alumina fibers, silica fibers, alumina fibers, other ceramic fibers, liquid crystal polymer (LCP) fibers, aramid fibers, polyethylene fibers, and a wisker such as wollastonite and potassium titanate. Examples of the plate filler include talc, mica, graphite, and wollastonite. Examples of the spherical filler include glass beads and glass balloons. Examples of the powder filler include calcium carbonate, dolomite, clay barium sulfate, titanium oxide, carbon black, conductive carbon, and micro-particle silica. Examples of the hetero filler include glass flakes and hetero cross-section glass fibers. Solid lubricants such as molybdenum disulfide, heat resistant resin particles such as oxybenzoyl polyester and polyimide, and coloring materials such as dyes and pigments can also be mentioned as examples of other components. The other component optionally used as described above may be used singly or two or more of the optional component may be used in combination. The optional component may be used in the amount of from 0 to 250 parts by weight, preferably from 0 to 70 parts by weight, more preferably from 0 to 50 parts by weight, and most preferably 0 to 25 parts by weight, each amount being based on 100 parts by weight of the liquid-crystalline polymer.

Furthermore, the liquid-crystalline polymer composition may contain one or two or more types of thermoplastic resins such as polyethylene, polypropylene, polyamide, polyester, polycarbonate, modified polyphenylene oxide, polyphenylene sulfide, polyether imide, polyether ketone and polyamideimide and heat-curable resins such as a phenol resin, an epoxy resin and polyimide.

### <Method of Producing Liquid-Crystalline Polymer Composition>

The liquid-crystalline polymer composition of the present invention is obtained, for example, by mixing the liquid-crystalline polymer, aromatic polysulfone resin and further other components to be used according to the need by using a Henschel mixer or a tumbler and then melt-kneading the mixture with an extruder to form a composition pellet. Also, the liquid-crystalline polymer composition of the present invention is obtained, for example, by introducing the liquid-crystalline polymer, aromatic polysulfone resin and further other components to be used according to the need into an extruder one after another from each different feeder to melt-knead. In the latter case, though the order of these components to be introduced into the extruder is any order, a method may be adopted in which infusible components are introduced after a thermoplastic resin is heat-melted in advance. Also, a combination of the above methods may be adopted, that is, a part of the components are mixed and dispersed in advance, and the mixture is charged into the remainder thermoplastic resin heat-melted in the extruder to knead, thereby forming a composition pellet. Also, the melt kneading is not necessarily carried out with an extruder, and a Banbury mixer or roll may be used. The composition is preferably pelletized because the pellet is easily handled in the subsequent injection molding or extrusion molding. In this case, as the extruder, a biaxial kneading extruder is preferably used because the dispersibility of each component can be improved.

### <Method of Molding Liquid-Crystalline Polymer Composition>

The liquid-crystalline polymer composition of the present invention can be applied to conventionally known melt-molding and preferably injection molding, extrusion molding, compression molding, blow molding, vacuum molding and press molding. Also, the liquid-crystalline polymer composition can be applied to film formation such as sheet molding, film molding using a T-die and inflation molding and melt spinning.

Particularly, injection molding is advantageously applied from the viewpoint that molded articles having various forms can be produced and this injection molding can attain high productivity.

In a preferred injection molding, first a flow initiation temperature FT (° C.) of the composition pellet is obtained. Here, the flow initiation temperature means a temperature at which a heat melt body has a melt viscosity of 4800 Pa·s (48000 poise) when it is extruded from a nozzle with heating at a rate of 4° C/min under a load of 9.81 MPa (100 kgf/cm²) by using a capillary tube rheometer provided with a nozzle having an inside diameter of 1 mm and a length of 10 mm. In the present invention, a flow characteristics evaluation apparatus “Flow Tester CFT-500D” manufactured by Shimadzu Corporation is used as the device for measuring the flow initiation temperature.

Then, based on the flow initiation temperature FT (° C.) of the composition pellet, the composition pellet is melted at a temperature (melt temperature) of (FT)° C. or more and (FT+250)° C. or less and injection-molded into a mold set to 0° C. or more. In this case, the composition pellet is preferably dried before the injection molding.

When the melt temperature of the composition is too low, the fluidity of the resin is so low that the resin cannot be sometimes completely filled into fine shape parts and the transferability of the resin to the surface of the mold is low, bringing about a tendency that the surface of the molded article is roughened, which is undesirable. When the melt temperature of the composition is too high, on the other hand, the liquid-crystalline polymer composition retained in the molding machine is easily decomposed, giving rise to easy occurrence of abnormal external appearance such as swelling of the surface of the molded article and easy generation of gases, which is undesirable. Considering stability and moldability of the composition, the melt temperature of the composition is preferably (FT+10)° C. or more and (FT+200)° C. or less and more preferably (FT+15)° C. or more and (FT+180)° C. or less.

The temperature of the mold is determined in consideration of the appearance, the temperature being not limited thereto, dimension and mechanical strength as well as productivity such as processability and molding cycle though it may be set to 0° C. or more as mentioned above. Typically, the temperature of the mold is preferably 40° C. or more, and more preferably 50° C. or more. When the temperature of the mold is too low, it is difficult to control the temperature of the mold in continuous molding and there is the case where the resulting variation in the temperature has an adverse influence on the molded article, and also the surface smoothness of the resulting molded article may be deteriorated. It is more advantageous that the temperature of the mold is higher from the viewpoint of improving the surface smoothness. However, if the temperature of the mold is too high, this brings about a reduced cooling effect, causing a longer time required for the cooling process, and therefore, the productivity is deteriorated and the molded article is deformed because of deteriorated releasability, which is undesirable. To mention further, if the temperature of the mold is too high, the engagement of the mold is degraded, and therefore, there is a possibility of breakage of the mold when the mold is opened or closed. It is preferable to properly optimize the upper limit of the temperature of the mold according to the type of the composition pellet described above to be applied, to prevent the decomposition of the composition pellet. The temperature of the mold is more preferably 50° C. or more and 220° C. or less and even more preferably 70° C. or more and 200° C. or less.

The liquid-crystalline polymer composition is excellent in process flowability, heat resistance, mechanical characteristics and flame retardance, and therefore, can be suitable for providing electric/electronic parts, structural members such as optical parts, mechanical parts and mechanism parts. For example, the liquid-crystalline polymer composition can be made into the following products: Examples of electric/electronic parts and optical parts include semiconductor production process-related products such as connectors, sockets, relay parts, coil bovines, optical-pickup lens holder, optical-pickup base, oscillators, print wiring boards, circuit boards, semiconductor packages, computer-related products, camera mirror lens barrels, optical sensor cases, compact camera module cases (packages and mirror lens barrels), projector-optical engine structural members, IC trays, and wafer carriers; household electric product parts such as VTRs, television sets, clothes irons, air conditioners, stereo players, vacuum cleaners, refrigerators, rice boilers, electric pots, and luminaire; luminaire parts such as lamp reflectors and lamp holders; audio products parts such as compact disks, laser disks, and speakers; communication devices parts such as optical cable ferules, telephone parts, facsimile parts and modems; copying machine/printer-related parts such as separating claws and heater holders; mechanical parts such as impellors, fan gears, gears, bearing, motor parts and cases; automotive parts such as automotive mechanism parts, engine parts, engine room interior parts, automotive electronic parts, and interior parts; cooking equipment such as microwave cooking pans and heat resistant table dishes, heat insulating and sound insulting materials such as floor materials and wall materials; support materials such as beams and columns; construction materials such as roof materials, or civil and construction materials; air planes, spacecraft and space device parts, radiation facility members such as atomic reactors, marine facility members, cleaning instruments, optical instrument parts, valves, pipes, nozzles, filters, membranes, medical instrument parts and medical materials, sensor parts, sanitary parts, sport supplies and leisure supplies. Examples

The present invention is described using the following Examples, but the present invention is not limited to the Examples. The liquid-crystalline polymer compositions obtained in Examples were evaluated by the methods described below.

### <Specific Gravity>

The liquid-crystalline polymer composition was molded into an ASTM No. 4 dumbbell by an injection molding machine and measured according to ASTM D792 (23° C.). Even if a test piece of 64×64×3 mm (thickness) and a test piece of 127 mm in length, 12.7 mm in width and 6.4 mm in thickness was used in place of the ASTM No. 4 dumbbell, the same results were obtained.

### <Deflection Temperature Under Load>

The liquid-crystallineline polymer composition was molded into a 6.4-mm-thick test piece (127 mm (length)×12.7 mm (width)×6.4 mm (thickness)) by an injection molding machine and measured according to ASTM D648.

### <Tensile Strength>

The liquid-crystalline polymer composition was molded into an ASTM No. 4 dumbbell by an injection molding machine and measured according to ASTM D638 (23° C.)

### <Izod Impact Strength>

The liquid-crystallineline polymer composition was molded into a 6.4-mm-thick test piece (127 mm (length)×12.7 mm (width)×6.4 mm (thickness)) by an injection molding machine and measured according to ASTM D256.

### <Liquid-Crystalline Polymer Resin>

A reactor equipped with a stirrer, a torque meter, a nitrogen gas introduction pipe, a temperature gauge and a reflux condenser was charged with 994.5 g (7.2 mol) of parahydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic acid anhydride, and 0.194 g of 1-methylimidazole as a catalyst and the mixture was stirred at ambient temperature for 15 minutes. After the atmosphere in the reactor was sufficiently replaced with a nitrogen gas, the temperature was raised with stirring. When the internal temperature reached 145° C., the mixture was stirred for 1 hour while keeping this temperature. Then, the mixture was heated up to 320° C. over 2 hours and 50 minutes while removing distilled acetic acid to be by-produced and unreacted acetic acid anhydride by distillation, and the reaction was considered to be completed when a rise in torque was observed, to obtain a prepolymer. The flow initiation temperature of the prepolymer was 261° C. The obtained prepolymer was cooled to ambient temperature and milled by a coarse mill to obtain a powder (particle diameter =about 0.1mm to about 1 mm) of a liquid crystalline polyester. Then, the milled particles were heated from ambient temperature to 250° C. over 1 hour and from 250° C. to 285° C. over 5 hours in a nitrogen atmosphere and retained at 285° C. for 3 hours to undergo a polymerization reaction in a solid phase. The flow initiation temperature of the obtained polyester was 327° C. The polyester obtained in this manner was used as the liquid-crystalline polymer (hereinafter abbreviated as “LCP1”).

### <Aromatic Polysulfone Resin>

As the aromatic polysulfone resin, the following compounds each having a repeat unit represented by the above formula (1) in which each of Ph¹ and Ph² is a p-phenylene group were used.

“Sumikaexcel 3600P” manufactured by Sumitomo Chemical Co., Ltd.: including no oxygen-containing groups, reduced viscosity 0.36.dl/g (hereinafter abbreviated as “PES1”).

“Sumikaexcel 4100P” manufactured by Sumitomo Chemical Co., Ltd.: including no oxygen-containing groups, reduced viscosity 0.41 dl/g (hereinafter abbreviated as “PES2”).

“Sumikaexcel 4800P” manufactured by Sumitomo Chemical Co., Ltd.: including no oxygen-containing groups, reduced viscosity 0.48 dl/g (hereinafter abbreviated as “PES3”).

“Sumikaexcel 5200P” manufactured by Sumitomo Chemical Co., Ltd.: including no oxygen-containing groups, reduced viscosity 0.52 dl/g (hereinafter abbreviated as “PESO”).

“Sumikaexcel 5003P” manufactured by Sumitomo Chemical Co., Ltd.: including oxygen-containing groups in an amount of 8.6×10⁻⁵/g in number, reduced viscosity 0.51 dl/g (hereinafter abbreviated as “PES5”).

Here, the amount (in number) of the oxygen-containing groups of the aromatic polysulfone resin per 1 g of the polysulfone resin was measured by dissolving a specified amount of the aromatic polysulfone resin in dimethylformamide, adding an excess amount of paratoluenesulfonic acid and then, using a potentiometric titrating device, titrating the solution using 0.05 mol/L of a potassium-methoxidetoluene methanol solution, reacting residual paratoluenesulfonic acid with the potassium methoxide, then, reacting the oxygen-containing groups (to be measured) of the aromatic polysulfone resin with the potassium methoxide to obtain the amount by mole of the potassium methoxide required for the reaction, and then dividing the amount by the above specified amount (g) of the polysulfone (A).

Also, the reduced viscosity of the aromatic polysulfone resin was obtained as follows: about 1 g of the aromatic polysulfone resin was dissolved in N,N-dimethylformamide to be a volume of 1 dl, the viscosity (η) of the obtained solution was measured at 25° C. by using an Ostwald's viscometer, also, the viscosity (fib) of the solvent N,N-dimethylformamide was measured at 25° C. by using the same Ostwald's viscometer, and the specific viscosity ratio ((η-η₀)/η₀) was divided by the concentration (about 1 g/dl) of the above solution.

### <Glass Fiber>

As the glass fiber, “Milled Glass Fiber EFH75-01” (hereinafter abbreviated as “GF1”), manufactured by Central Glass Co., Ltd. was used.

### EXAMPLES 1 TO 4 AND COMPARATIVE EXAMPLES 1 TO 6

In each of Examples and Comparative Examples, the components shown in Table 1 were mixed in the ratios shown in Table 1 by using a Henschel mixer, and then the mixture was granulated at a cylinder temperature of 360° C. by using a biaxial extruder (“PCM-30” manufactured by Ikegai Corporation) to obtain a pellet of a liquid-crystalline polymer composition (LCP1). After the LCP1 pellet was dried at 180° C. for 12 hours by using a hot-air circulation type drier, it was injection-molded at a cylinder temperature of 360° C. and a mold temperature shown in Table 1 by using an injection molding machine (“PS40E-SASE model” manufactured by Nissei Plastic Industrial Co., Ltd.) to obtain each of the above test pieces, which was then evaluated by each of the above tests. The results were shown in Table 1.

### COMPARATIVE EXAMPLES 7 AND 8

In each of Comparative Examples, LCP1 was granulated at a cylinder temperature of 360° C. by using a biaxial extruder (“PCM-30” manufactured by Ikegai Corporation) to obtain a pellet of a liquid-crystalline polymer composition. After the composition pellet was dried at 180° C. for 12 hours by using a hot-air circulation type drier, it was injection-molded at a cylinder temperature of 360° C. and a mold temperature shown in Table 1 by using an injection molding machine (“PS40E-SASE model” manufactured by Nissei Plastic Industrial Co., Ltd.) to obtain each of the above test pieces, which was then evaluated by each of the above tests. The results were shown in Table 1.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| LCP1 | (Parts by | 90 | 90 | 85 | 95 | 90 | 90 | 90 |
| | weight) | | | | | | | |
| PES1 | (Parts by | — | — | — | — | 10 | — | — |
| | weight) | | | | | | | |
| PES2 | (Parts by | — | — | — | — | — | 10 | — |
| | weight) | | | | | | | |
| PES3 | (Parts by | — | — | — | — | — | — | 10 |
| | weight) | | | | | | | |
| PES4 | (Parts by | — | — | — | — | — | — | — |
| | weight) | | | | | | | |
| PES5 | (Parts by | 10 | 10 | 15 | 5 | — | — | — |
| | weight) | | | | | | | |
| GF1 | (Parts by | — | — | — | — | — | — | — |
| | weight) | | | | | | | |
| Mold | (° C.) | 130 | 70 | 130 | 130 | 130 | 130 | 130 |
| temperature | | | | | | | | |
| Specific | | 1.38 | 13.8 | 1.38 | 1.38 | 1.38 | 1.38 | 1.38 |
| gravity | | | | | | | | |
| Deflection | (° C.) | 251 | 253 | 252 | 239 | 227 | 230 | 229 |
| temperature | | | | | | | | |
| Tensile | (MPa) | 216 | 210 | 207 | 186 | 192 | 181 | 183 |
| strength | | | | | | | | |
| Izod impact | (J/m) | 1400 | 1500 | 1030 | 1220 | 1400 | 1260 | 1370 |
| test | | | | | | | | |

| | | Comparative | Comparative | Comparative | Comparative | Comparative |
|---|---|---|---|---|---|---|
| | | Example 4 | Example 5 | Example 6 | Example 7 | Example 8 |
| LCP1 | (Parts by | 90 | 60 | 60 | 100 | 100 |
| | weight) | | | | | |
| PES1 | (Parts by | — | — | — | — | — |
| | weight) | | | | | |
| PES2 | (Parts by | — | — | — | — | — |
| | weight) | | | | | |
| PES3 | (Parts by | — | — | — | — | — |
| | weight) | | | | | |
| PES4 | (Parts by | 10 | — | — | — | — |
| | weight) | | | | | |
| PES5 | (Parts by | — | — | — | — | — |
| | weight) | | | | | |
| GF1 | (Parts by | — | 40 | 40 | — | — |
| | weight) | | | | | |
| Mold | (° C.) | 130 | 130 | 70 | 130 | 70 |
| temperature | | | | | | |
| Specific | | 1.38 | 1.70 | 1.70 | 1.38 | 1.38 |
| gravity | | | | | | |
| Deflection | (° C.) | 224 | 276 | 275 | 260 | 231 |
| temperature | | | | | | |
| Tensile | (MPa) | 192 | 145 | 143 | 177 | 125 |
| strength | | | | | | |
| Izod impact | (J/m) | 1480 | 410 | 420 | 1060 | 950 |
| test | | | | | | |

It is found from Comparative Examples 7 and 8 that if a liquid-crystalline polymer is singly used, the load deflection temperature and tensile strength largely vary due to the mold temperature in injection molding and it is therefore difficult to obtain a molded article having stable properties.

It is found from Comparative Examples 5 and 6 that though the load deflection temperature and tensile strength do not vary due to the mold temperature in injection molding by compounding glass fibers to the liquid-crystalline polymer, enabling the production of a molded article having stable properties, the intrinsic performance of the liquid-crystalline polymer is sacrificed as shown by, for example, the considerable increase in specific gravity, reduction in tensile strength, and considerable reduction in Izod impact strength.

On the other hand, it is found from Example 1 and 2 that the load deflection temperature and tensile strength do not vary due to the mold temperature by compounding the aromatic polysulfone resin containing a specified amount of oxygen-containing groups in the liquid-crystalline polymer, enabling the production of a molded article having stable properties. Also, as is clear from the comparison between Examples 1 to 4 and Comparative Examples 1 to 4, it is found that the load deflection temperature and tensile strength are significantly reduced when the aromatic polysulfone resin having no oxygen-containing groups is used.

As mentioned above, it is found that a molded article having excellent properties is stably obtained which is improved in tensile strength and Izod impact strength while suppressing the reduction in load deflection temperature by compounding the aromatic polysulfone resin containing a specified amount of oxygen-containing groups in the liquid-crystalline polymer.

What is claimed is:

1. A liquid-crystalline polymer composition comprising:
a liquid-crystalline polymer and
an aromatic polysulfone resin having oxygen-containing groups selected from among hydroxyl groups and oxyanion groups,
in an amount of 6×10⁻⁵ or more in number per 1 g of the polysulfone resin.

2. The composition according to claim 1, wherein the aromatic polysulfone resin is contained in the composition in an amount of from 0.5 to 100 parts by weight based on 100 parts by weight of the liquid-crystalline polymer.

3. The composition according to claim 1, wherein the aromatic polysulfone resin has a repeat unit represented by the following formula (1):
-Ph¹-SO₂-Ph²-O— (1)
wherein Ph¹ and Ph² each independently represent a group represented by the following formula (4): 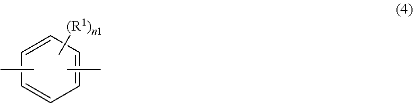
wherein R¹ represents an alkyl group having 1 to 3 carbon atoms, a halogeno group, a sulfo group, a nitro group, an amino group, a carboxyl group, a phenyl group, or an oxygen-containing group selected from among a hydroxyl group and an oxyanion group; and n1 represents an integer from 0 to 2, wherein two R¹s may be the same or different when n1 is 2.

4. The composition according to claim 1, wherein the aromatic polysulfone resin has a reduced viscosity of from 0.25 to 0.6 dl/g.

5. A molded article obtained from the composition according to claim 1.
